(19) United States
(12) Patent Application Publication
(10) Pub. No.: US 2009/0317571 A1
(43) Pub. Date: Dec. 24, 2009

(54) Vehicle emblem enhancer

(76) Inventor: Nicholas Anthony Geracitano, Tabernacle, NJ (US)

Correspondence Address: Nicholas Geracitano, 27 Wynn Rd, Tabernacle, NJ, 08088, US

(21) Appl. No.: 12/214,888

(22) Filed: Jun. 23, 2008

(51) Int. Cl. B60R 13/04

(52) U.S. Cl. 428/31

(57) ABSTRACT

A part or set of parts designed to supplement the appearance of a vehicle's emblem by fitting precisely within (FIGS. 1-2) and/or around (FIG. 3) an emblem's structure. Emblems located on the metal surface of an auto will be supplemented with parts crafted from magnetic sheeting, and emblems located on a vehicle's grille will be supplemented by the attachment of plastic or metal inserts (FIG. 5). This invention offers the advantages of adding a customized accessory to one's vehicle with a wide array of possible color schemes and designs while remaining inexpensive enough to appeal to a broad audience.

### CROSS-REFERENCE

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to the cosmetic enhancement of one's vehicle's emblem's appearance, specifically through the use of specifically designed magnetic decals and/or plastic inserts.

2. Prior Art

The auto-accessories market is filled with a multitude of products that are designed solely to improve the aesthetics of one's vehicle. However, the products that actually work to supplement the design of the vehicle itself are generally expensive, and they are marketed to a small demographic of car owners who have the time, money, and enthusiasm to customize their personal vehicles. The less expensive and more commonplace cosmetic products in the auto-accessory market are not conducive with the design of a particular vehicle, but are items that exist to express a view that are often placed haphazardly on the back end of a car or truck. These include magnetic decals of a sports-team's logo, magnetic ribbons that support the awareness of a cause, and the ever-popular “Jesus Fish” and its variants. The invention described below combines the inexpensive, easy-to-install, and simple qualities of these common products with the aesthetic benefits of a customized accessory to create an entirely new look for the focal center-point of one's vehicle: the emblem.

Auto emblems are designed to be simple, eye-catching, and aesthetically pleasing, yet the commonality that exists in seeing so many millions of identical logos creates a lack of individual spirit that so many people wish to express through their vehicles. Consumers try to compensate for this by either spending too much or by purchasing novelties that draw attention away from the commonplace appearance of their car. A vehicle's emblems tend to be the first parts to be removed when someone customizes their vehicle, causing many to purchase expensive new grilles for that purpose. As for emblems fastened to the rear, one may notice that many modified cars have had them simply torn out leaving behind the holes where they were fastened.

In choosing either of the above options there is the possible drawback of decreasing the resale value of one's vehicle. As for the expensive option of installing customized parts on a car or truck, it is common knowledge that modified vehicles are notorious for their low resale values. Also, those who have placed a car magnet on their trunk some years ago will often see a permanent outline of their “Support the Troops” ribbon emblazoned into their car's finish. There is a large gap in the market that falls between these two types of products that this invention will fill in.

3. Objects and Advantages

The Vehicle Emblem Enhancer is a single idea with two methods of usage: For emblems that are attached directly to the metal body of a vehicle, specially crafted magnetic sheets will be placed in the spaces within the emblem; For emblems located within a vehicle's grill, there will be plastic inserts fit snugly within to the same effect. The end result will create a completely different and unique look for the centerpiece of the vehicle, both from the front and the rear.

The cost of this product will be highly affordable due to the low production cost of the materials needed, and consumers will have the option to choose from several products of different color schemes from all of the basic solid colors to designs such as flames, stripes, the colors of a nation's flag, or the colors of one's alma mater. Installation and removal will take very little time and effort, allowing for quick changes between designs if desired.

Several objects and advantages of this invention are:

(a) to provide a cosmetic enhancement to the focal center-point of one's vehicle in an effort to supplement the designs of the vehicle rather than to work around them;

(b) to provide a cosmetic enhancement to a vehicle's emblem using a wide selection of colors and patterns for the consumer to choose from;

(c) to provide a cosmetic enhancement that is easy to install and remove by the lay consumer;

(d) to provide a cosmetic enhancement that will not decrease the value of one's vehicle after installation or removal; and

(e) to provide a cosmetic enhancement that is affordable and available to the general public.

All of the above descriptions are in reference specifically to the area within and around a vehicle's emblem. Further objects and advantages will become apparent from a consideration of the description and drawings provided.

### SUMMARY

The present invention consists of a set of parts composed of colored magnetic sheets or plastic inserts that are designed to enhance the aesthetics of a vehicle's emblem.

### DRAWINGS—FIGURES

FIG. 1 resembles a Honda emblem.

FIG. 2 resembles a Mercedes Benz emblem.

FIG. 3 resembles a Chevrolet emblem.

FIG. 4 resembles a Mitsubishi emblem.

FIG. 5 resembles a Mazda emblem.

FIG. 6 resembles a Acura emblem.

### DETAILED DESCRIPTION

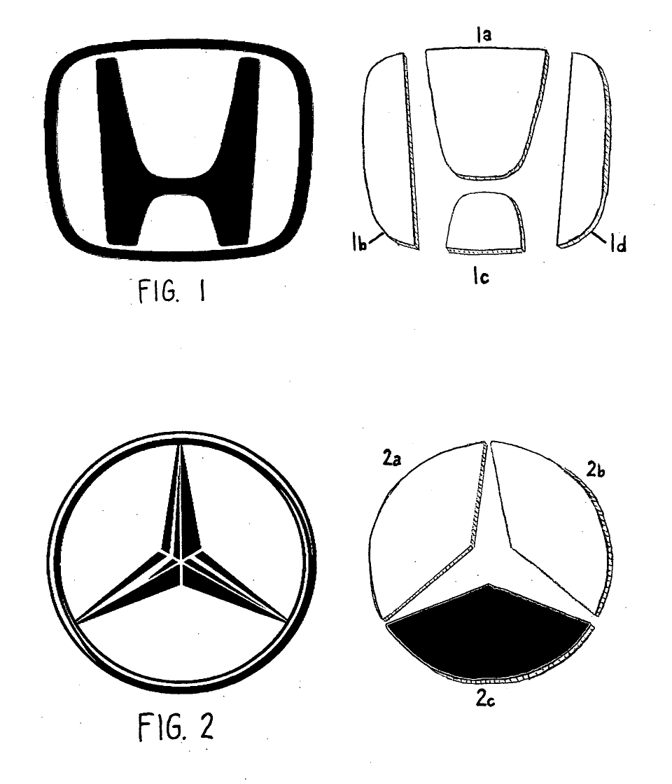

The parts labeled alphabetically shown in FIGS. 1, 2, 3, 4, and 6 are comprised of flexible magnetic material which allows them to be adhered to the curvature of the metal upon which the emblem is mounted. The surface of FIGS. 1, 2, 3, 4, and 6 are to be comprised of a covering of vinyl or a similar substance to be determined which will best display colors and artwork while being resistant to the elements. The depth of all of the figures below will vary dependant on the dimensions of the actual emblem that the invention supplements; A characteristic which applies to all designs for emblems not mentioned here as well.

Adjacent to FIG. 1 is an illustration of the present invention, with FIGS. 1a, 1b, 1c, and 1d shaped to fit into the upper, left, lower, and right spaces within the emblem respectively. These parts are shaded to represent a design of a solid color throughout the surface.

Adjacent to FIG. 2 are parts 2a, 2b, and 2c which are shaped to fit into the upper-left, upper-right, and lower spaces within the emblem respectively. These parts are shaded to represent three different colors, possibly those of a nation's tri-color flag such as Italy, France, or Mexico.

Below FIG. 3 is an example of the present invention shaped to fit solely around an emblem, as opposed to filling in the spaces within one. 3a displays a representation of the United States' flag surrounding an emblem.

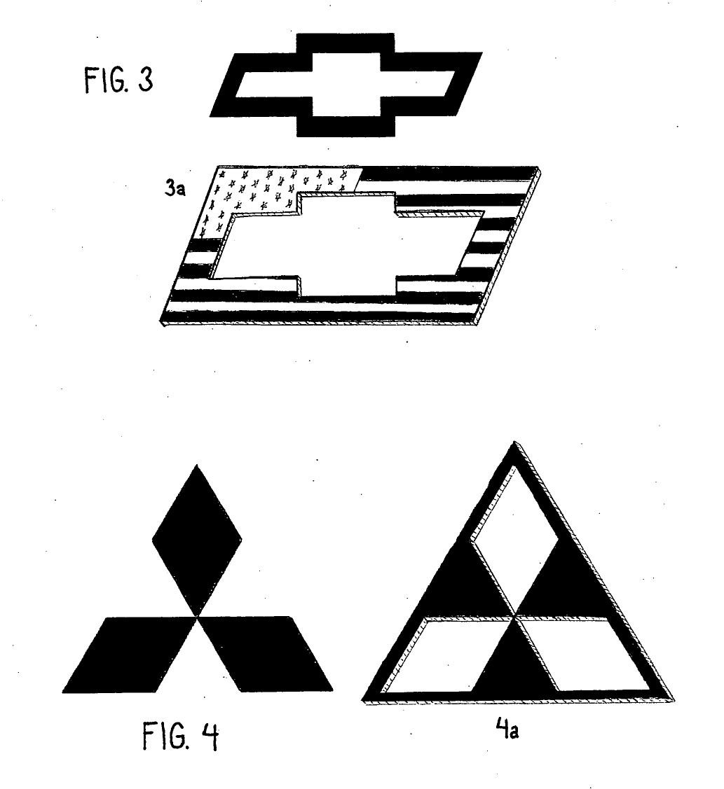

Adjacent to FIG. 4 is another example of a magnet shaped to fit around an emblem. 4a is shaded to represent a solid color.

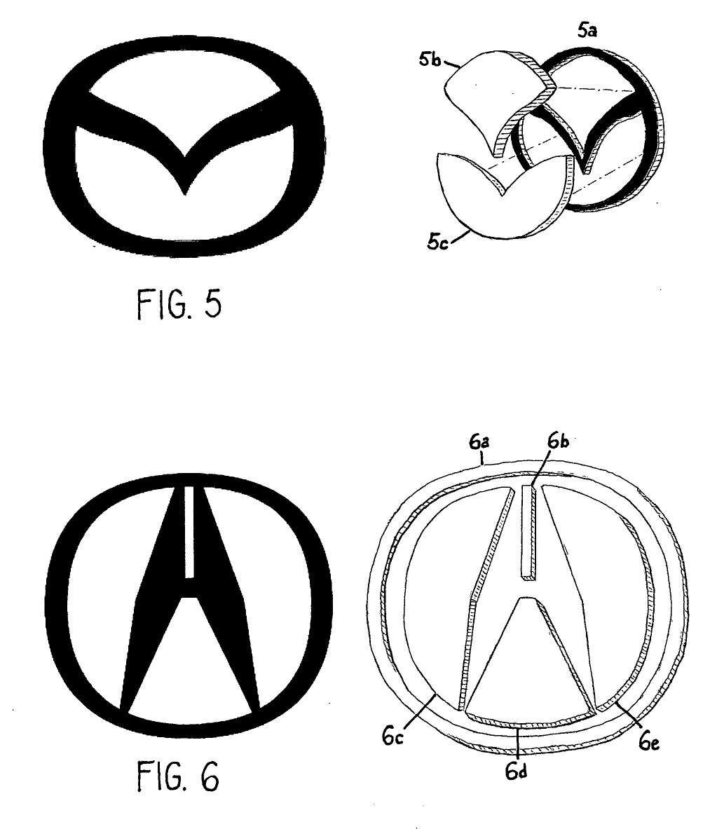

FIG. 5 displays the use of colored plastic inserts to be inserted within the spaces of an emblem located in a vehicle's grille. 5a represents the manufacturer's emblem with 5b and 5c representing the plastic inserts to be inserted. The inserts may be secured in place with a non-abrasive adhesive.

FIG. 6 is composed of five magnetic parts that both fit within and around an emblem. 6a is designed to fit around the emblem's perimeter, while 6b, 6c, 6d, and 6e are placed in the spaces within the emblem. This figure is shaded to represent a solid color.

### FIGS. 1-6—Additional Embodiments

There are various possibilities with regard to the composition of the present invention, as different materials may better suit the different models of vehicles that the invention is attached to. Some models of vehicles may require the invention to have a stronger than average magnetic force in order to stay put, while others may need a different means of attachment altogether. Possible attachment options for grille-inserts other than an adhesive may be the application of an impressionable, durable, non-slip rubber or rubber-like substance as a coating for the areas of contact with the emblem. Another possibility concerning grille-inserts involves grilles made of metal, which would allow the inserts to be attached by magnetic force rather than by an adhesive. More prestigious vehicles may find a higher quality grille-insert than one comprising of plastic to be more appropriate, such as an insert made of a metal alloy. It may also be found, for example, that the grille-inserts are capable of containing LED lighting for an added effect.

### Advantages

The description above provides a number of advantages of the Vehicle Emblem Enhancer:

(a) Each part is designed to precisely supplement the structure of a specific auto make and model's emblem.

(b) A wide assortment of colors, patterns, and symbols are able to be displayed.

(c) The simple design of the invention allows the consumer to install and remove it with ease.

(d) The quality and placement of the materials involved will not diminish the value of a vehicle after removal.

(e) The low cost of the materials will keep most versions of the product less expensive and more available.

While the above description contains many specific details, these should not be seen as the boundaries of the invention but as a few manifestations thereof. There are countless other ways to utilize the invention's main theme of supplementing an emblem's design. Also, future technologies and materials may come to replace those specified above, or a vehicle's emblem may take on different forms other than have been described here. The invention's scope should be determined by the appended claims and their legal equivalents as opposed to by the examples given.

I claim:

1. A vehicle accessory that supplements the preexisting design of a vehicle's emblem using the spaces within and the immediate area surrounding it.

2. The composition of claim 1, in the case of an emblem being attached directly to the metal surface of a vehicle, to be comprising of a flexible magnetic-sheet material.

3. The composition of claim 1, in the case of an emblem being located on or within a vehicle's grill or other location similar in structure, to be comprising of a durable plastic or metal material, and which may be inserted and attached using adhesives or clips.

4. The physical design of claim 1 to be crafted specifically to fit in and/or around the various emblems of different autos' makes and models.

5. The physical design of claim 1 to create the appearance of seamlessness through precise manufacture and placement within and around an emblem.

6. The graphic design(s) on the outer surface of claim 1 to depict any amount of colors, designs, symbols, and themes as are permissible by law.

7. Usage of materials other than magnetic or plastic materials that are employed to create a similar aesthetic effect as claim 1 states.
